(19) United States
(12) Patent Application Publication
(10) Pub. No.: US 2013/0019963 A1
(43) Pub. Date: Jan. 24, 2013

(54) FUEL CUT-OFF VALVE ASSEMBLIES

(71) Applicant: Masanori SUGIURA, Obu-shi (JP)

(72) Inventor: Masanori SUGIURA, Obu-shi (JP)

(73) Assignee: AISAN KOGYO KABUSHIKI KAISHA, Obu-shi (JP)

(21) Appl. No.: 13/551,773

(22) Filed: Jul. 18, 2012

(30) Foreign Application Priority Data
Jul. 19, 2011 (JP) 2011-157951

(51) Int. Cl. F16K 31/16

(52) U.S. Cl. 137/409

(57) ABSTRACT

A fuel cut-off valve assembly may include a housing disposed within a fuel tank and defining therein a float chamber communicating with a space defined in the fuel tank. The housing has a fuel vapor outlet hole, so that fuel vapor can flow from within the float chamber to a fuel vapor processing device. A float valve may be received within the float chamber so as to be vertically movable for opening and closing the fuel vapor outlet hole in response to change in a level of fuel within the fuel tank. The float valve may have a valve body and a buoyancy center positioned at a level higher than a central position of the valve body with respect to the height of the valve body.

This application claims priority to Japanese patent application serial number 2011-157951, the contents of which are incorporated herein by reference.

### BACKGROUND OF THE INVENTION

1. Field of the Invention

Embodiments of the present invention relate to fuel cut-off valve assemblies that may be mounted within fuel tanks of vehicles, such as automobiles.

2. Description of the Related Art

JP-A-11-254930 teaches a known fuel cut-off valve assembly. FIG. 7 shows a vertical sectional view of the known fuel cut-off valve assembly disclosed in this document. Referring to FIG. 7, a fuel cut-off valve assembly 100 includes a housing 110 disposed in a fuel tank of an automobile, and a float valve 102 vertically and movably arranged within a float chamber 110a defined in the housing 110. A fuel vapor outlet hole 113 is formed in an upper wall 112 of the housing 110 and communicates with a canister via an evaporation passage, i.e., a fuel vapor passage (not shown). Communication holes 131 are formed in a lower wall 130 of the housing 110. The float valve 102 includes a cylindrical valve body 102a and a valve portion 120 formed on an upper surface of the valve body 102a and opposed to the fuel vapor outlet hole 113. During normal conditions, the float valve 102 is positioned at a lowermost position, so that the valve portion 120 opens the fuel vapor outlet hole 113. In this way, fuel vapor produced within the fuel tank may flow into the float chamber 110a via the communication holes 131 and further into the canister via the fuel vapor outlet hole 113. If the fuel level within the housing 110 rises higher than a predetermined buoyancy center level of the float valve 102, for example, due to tilting or overturning of the automobile, the float valve 102 floats upward due to its buoyancy to close the fuel vapor outlet hole 113 by the valve portion 120. In this way, the fuel vapor is prevented from escaping from the fuel vapor outlet hole 113.

When this fuel cut-off valve assembly 100 is used, it is necessary to have a full load fuel level 100L within the fuel tank such that the float valve 102 is positioned at the lowermost position when the fuel is at the full load fuel level 100L. In addition, because the valve body 102a having a cylindrical shape has a height greater than its outer diameter, it is necessary to set the full load fuel level 100L to be relatively low. The above document is silent as to the buoyancy center of the float valve 102 and it cannot be known as to the position of the buoyancy center. However, in general, a buoyancy center is set to be lower than a middle position with respect to the height of a valve body in order that the valve body can receive buoyancy earlier by the fuel filled within a fuel tank. Therefore, it is necessary to set the full load fuel level to be relatively low also for this reason. Lowering the full load fuel level may lead to an increase in the region occupied by the gas, i.e., the dead space, within the fuel tank when the fuel is at the full load level. Eventually, the maximum allowable capacity of fuel within the fuel tank may be reduced.

Therefore, there has been a need in the art for a fuel cut-off valve assembly that can decrease the dead space within a fuel tank and can eventually increase the maximum allowable fuel capacity of the fuel tank.

### SUMMARY OF THE INVENTION

In one aspect according to the present teachings, a fuel cut-off valve assembly may include a housing disposed within a fuel tank and defining therein a float chamber communicating with a space defined in the fuel tank. The housing has a fuel vapor outlet hole, so that fuel vapor can flow from within the float chamber to a fuel vapor processing device. A float valve may be received within the float chamber so as to be vertically movable for opening and closing the fuel vapor outlet hole in response to a change in the level of fuel within the fuel tank. The float valve has a valve body and a buoyancy center positioned at a higher level than a middle position of the valve body with respect to the height of the valve body.

### BRIEF DESCRIPTION OF THE DRAWINGS

FIG. 1 is an exploded perspective view of a fuel cut-off valve assembly according to a representative embodiment;

FIG. 2 is a vertical sectional view of the fuel cut-off valve assembly in an open state;

FIG. 3 is a vertical sectional view similar to FIG. 2 but showing a closed state of the fuel cut-off valve assembly;

FIG. 4 is a horizontal sectional view of the fuel cut-off valve assembly;

FIG. 5 is a side view of a float valve of the fuel cut-off valve assembly;

FIG. 6 is a vertical sectional view similar to FIG. 2 but showing the state where the fuel cut-off valve assembly is inclined; and

FIG. 7 is a vertical sectional view of a known fuel cut-off valve assembly.

### DETAILED DESCRIPTION OF THE INVENTION

Each of the additional features and teachings disclosed above and below may be utilized separately or in conjunction with other features and teachings to provide improved fuel cut-off valve assemblies. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings. Various examples will now be described with reference to the drawings.

In one example, a fuel cut-off valve assembly includes a housing and a float valve. The housing may be disposed at a gaseous phase space within a fuel tank and define therein a float chamber. The float valve may be vertically movably received within the float chamber. The housing preferably includes at least one first communication hole communicating between a lower portion of the float chamber, at least one second communication hole formed in a side wall of the housing, and a fuel vapor outlet hole formed in an upper wall of the housing. The float valve includes a valve body and a valve portion configured to close the fuel vapor outlet hole as the float valve moves upward due to buoyancy created as fuel flows into the float chamber. The valve body preferably has a flattened shape. A buoyancy center of the float valve is positioned to be higher than a middle position with respect to a height of the valve body.

Because the valve body has a flattened shape, the full load fuel level can be set at a higher level. In addition, because the buoyancy center of the float valve is positioned to be higher than a middle position with respect to the height of the valve body, it is possible to set the full load fuel level to be higher than in the case where the buoyancy center of the float valve is positioned lower than the middle position of the valve body. Therefore, it is possible to reduce the dead space within the fuel tank and to eventually increase the fuel capacity of the fuel tank.

The at least one second communication hole may be positioned at substantially the same level as the buoyancy center or higher than the buoyancy center when the float valve is at a lowermost position within the housing. With this arrangement, even in the event that fuel droplets are spread due to ruffling of the surface of fuel within the fuel tank, such fuel droplets may be prevented from flowing into the at least one second communication hole and being discharged from the fuel vapor outlet hole via the float chamber.

The loss in pressure of gas flowing through the at least one second communication hole is determined to be smaller than the loss in pressure of gas flowing though the fuel vapor outlet hole. With this arrangement, when the fuel tank is tilted or overturned, it is possible to inhibit the pressure within the float chamber from being decreased to be lower than the pressure within the region occupied by the gas of the fuel tank. Hence, it is possible to inhibit leakage of fuel through the fuel vapor outlet hole, which may be caused by an abrupt rise in the fuel level within the float chamber prior to closing of the float valve.

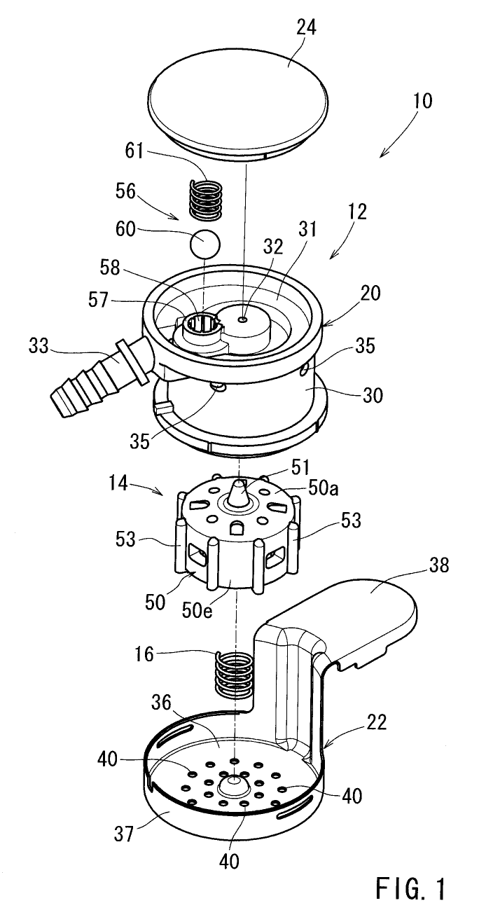

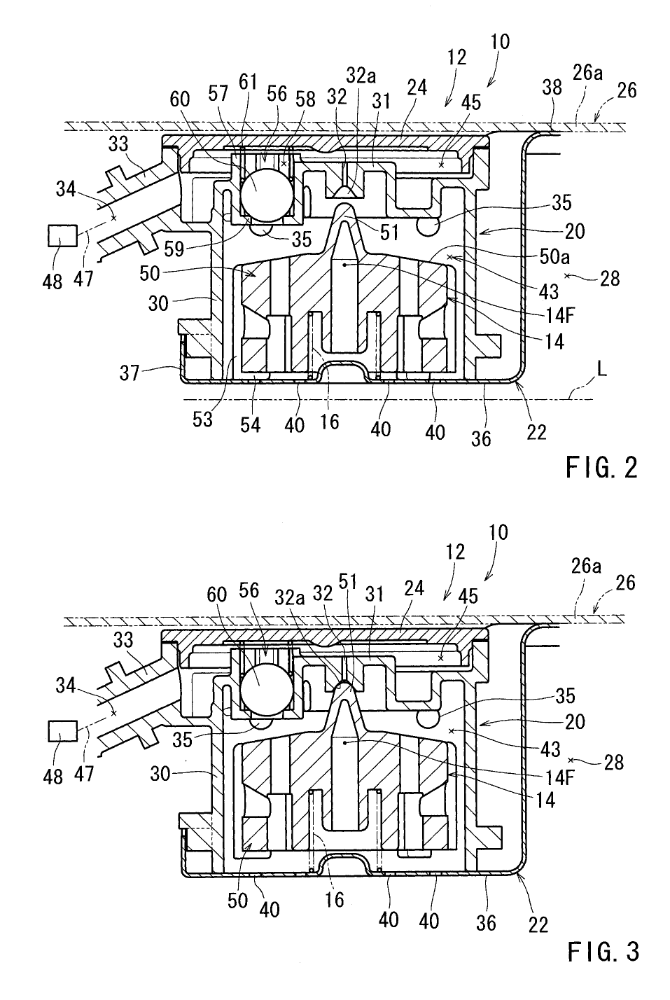

A representative embodiment will now be described with reference to FIGS. 1 to 6. A fuel cut-off valve assembly of this embodiment is of a type also known as a rollover valve or a fuel out-flow preventing valve. The vertical direction in FIG. 2 corresponds to the vertical direction with respect to a vehicle or a fuel tank mounted to the vehicle.

Referring to FIG. 1, the fuel cut-off valve assembly 10 may generally include a housing 12, a float valve 14 and a valve spring 16. The housing 12 may include a housing body 20, a retainer 22 and a cover 24. As shown in FIG. 2, the housing 12 may be attached to the lower surface of an upper wall 26a of a fuel tank 26, so that the fuel cut-off valve assembly 10 is positioned in a region 28 occupied by gas within a space defined in the fuel tank 26.

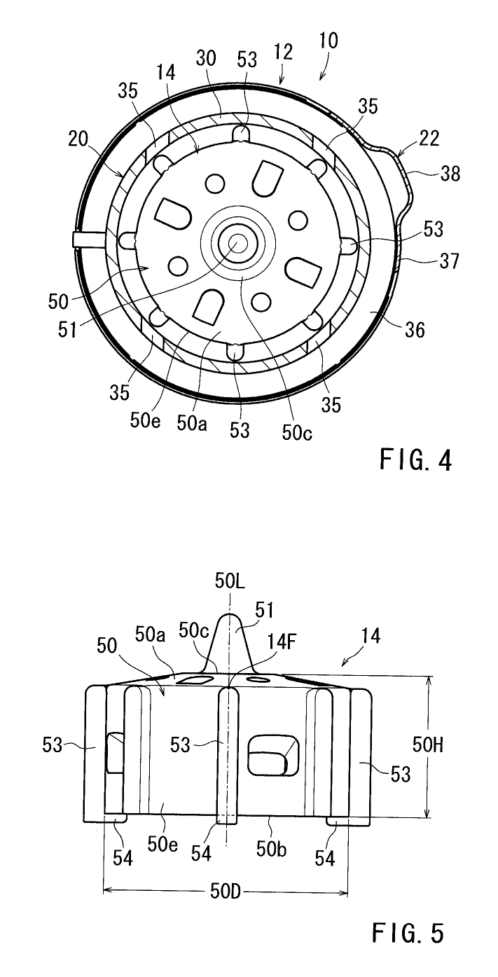

The housing body 20 will now be described. As shown in FIG. 2, the housing body 20 includes a side wall 30 and an upper wall 31. The side wall 30 has a substantially cylindrical shape. The upper wall 31 is formed to close the upper opening of the side wall 30 at a position lower than the upper end of the side wall 30. A cylindrical fuel vapor outlet hole 32 is formed in the central portion of the upper wall 31 to extend vertically therethrough. A valve seat 32a is formed around the lower opening of the fuel vapor outlet hole 32. A connection tube portion 33 is formed with the upper end of the side wall 30 and communicates with a communication chamber 45 defined within the upper end portion of the side wall 30 as will be explained later. The connection tube portion 33 protrudes laterally outward (leftward as viewed in FIG. 1) from the side wall 30. A connection passage 34 is defined in the connection tube portion 33. A plurality of circular gas communication holes 35 are formed in the side wall 30 at a position adjacent to the lower side of the upper wall portion 31 so as to extend throughout the thickness of the side wall 30 in the radial direction (see FIG. 4). In this embodiment, four gas communication holes 35 are provided and are spaced equally from each other in the circumferential direction of the side wall 30. The housing body 20 may be a resin mold product.

Returning to FIG. 1, the retainer 22 includes a circular bottom plate 36, an annular side plate 37 extending upward from the outer circumferential edge of the bottom plate 36, and a handle-like portion 38. The handle-like portion 38 includes a lower part extending upward from the side plate 37 and an upper part extending radially outward from the upper end of the lower part. A plurality of circular communication holes 40 are dispersedly formed in the bottom plate 36 to extend vertically as viewed in FIG. 2 throughout the thickness of the bottom plate 36. The retainer 22 may be formed as a one-piece member, for example, through press-molding of a metal plate.

The retainer 22 may be mounted to the housing body 20 by fitting the side plate 37 with the lower end portion of the side wall 30 of the housing body 20 (see FIG. 2). Therefore, the lower opening of the side wall 30 is covered by the bottom plate 36 of the retainer 22, so that a cylindrical float chamber 43 is defined within the housing body 20 between the upper wall 31 and the bottom plate 36 of the retainer 22. Thus, the bottom plate 36 serves as a bottom wall of the float chamber 43, and the retainer 22 serves as a bottom wall forming member. The upper part of the handle-like portion 38 may be fixedly attached to the lower surface of the upper wall 26a of the fuel tank 26, for example, by welding.

As shown in FIG. 2, the cover 24 may have a circular disk shape and may be a resin mold product. The cover 24 may be fitted into the upper end portion of the side wall 30 of the housing body 20 (see FIG. 2). Therefore, the upper opening of the upper end portion of the side wall 30 is closed by the cover 24. With this arrangement, a communication chamber 45 is defined within the upper end portion of the side wall 30 between the upper wall 31 and the cover 24. The communication chamber 45 communicates with the float chamber 43 via the fuel vapor outlet hole 32 opened at the valve seat 32a and also communicates with the connection passage 34. In this way, the communication chamber 45 and the connection passage 34 together form a communication path for the flow of fuel vapor. The connection tube portion 33 may be connected to a fuel vapor processing device or a canister 48 via a piping member 47. The piping member 47 may be a hose or the like and may serve as a fuel vapor passage. The canister 48 may be arranged externally around the fuel tank 26.

The float valve 14 will now be described. As shown in FIG. 5, the float valve 14 may include a cylindrical valve body 50 and a cone-shaped valve portion 51 protruding upward from the central portion of the valve body 50 so as to be coaxial therewith. More specifically, the valve body 50 has a lower end surface 50b, an upper end surface 50c and a cylindrical outer circumferential surface 50e. The lower end surface 50b and the upper end surface 50c may extend perpendicular to the central line (central axis) 50L of the valve body 50. The valve portion 51 may be formed on the upper end surface 50c. Between the outer peripheral edge of the upper end surface 50c and the upper end edge of the outer circumferential surface 50e, a conical surface 50a is formed so as to be inclined gently downward from the outer peripheral edge of the upper end surface 50c toward the upper end edge of the outer circumferential surface 50e. A plurality of ribs 53 may be formed on the outer circumferential surface 50e and extend vertically in parallel to the axial direction of the valve body 50. In this embodiment, eight ribs 53 are provided and spaced equally from each other in the circumferential direction (see FIG. 4). As shown in FIG. 5, a plurality of support projections 54 may be formed on the outer peripheral portion of the lower end surface 50b of the valve body 50 so as to extend in the radial direction. In this embodiment, four support projections 54 are provided and spaced equally from each other in the circumferential direction. The support projections 54 are formed in series with the lower ends of four of the ribs 53 positioned alternately in the circumferential direction. The float valve 14 may be a resin mold product.

The float valve 14 may be moveably and vertically arranged within the float chamber 43 (see FIG. 2). The valve portion 51 of the float valve 14 may be positioned on the same axis as the central axis of the valve seat 32a. The ribs 53 of the float valve 14 may slidably contact the inner circumferential surface of the side wall 30 (see FIG. 4) or may be spaced by a little distance therefrom. Therefore, the float valve 14 can move in the axial direction (vertical direction) along the side wall 30.

The valve spring 16 will now be described. As shown in FIG. 1, the valve spring 16 may be a coil spring interposed between the retainer 22 and the float valve 14 (see FIG. 2). The biasing force of the valve spring 16 is set such that it does not cause upward movement of the float valve 14 during the normal condition of the vehicle but rather can assist the buoyancy applied to the float valve 14 by the fuel transferred into the float chamber 43. During the normal condition, the float valve 14 is lowered against the biasing force of the valve spring 16 by the gravity force of the float valve 14 so as to contact the bottom plate 36, so that the float valve 14 is supported on the bottom plate 36. This supported position of the float valve 14 will be hereinafter called a lowermost position.

As shown in FIG. 2, a relief valve 56 may be disposed within the cut-off valve assembly 10. The relief valve 56 may include a valve housing 57, a valve member 60 and a relief spring 61 (see FIG. 1). The valve housing 57 may have a cylindrical tubular shape and may extend in the vertical direction. The valve housing 57 may be formed integrally with a part (left side part as viewed in FIG. 2) of the upper wall 31 of the housing body 20. A relief passage 58 may be formed within the valve housing 57 so as to provide communication between the communication chamber 45 and the float chamber 43. An annular valve seat 59 defining a communication hole therein may be formed with the lower end of the valve housing 57 so as to extend radially inwardly therefrom. The valve member 60 may be a ball and may be vertically introduced into the relief passage 58. As the valve member 60 moves downward, the valve member 60 closes the communication hole of the valve seat 59. On the other hand, as the valve member 60 moves upward away from the valve seat, the communication hole is opened. The relief spring 61 normally biases the valve member 60 downward in a valve closing direction.

The valve body 50 of the float valve 14 has a flattened shape with an outer diameter 50D and a height 50H that is smaller than the outer diameter 50D (see FIG. 5). In this embodiment, the height 50H is set to be about ⅗ of the outer diameter 50D. Here, the valve portion 51, the ribs 53 and the support projections 54 are disregarded in determining the sizes of the height 50H and the outer diameter 50D. Therefore, the outer diameter 50D of the valve body 50 corresponds to the diameter of the outer circumferential surface 50e. The height 50H of the valve body 50 corresponds to the height (axial length) measured from the lower end surface 50b to the upper end surface 50c.

A buoyancy center 14F of the float valve 14 is set at a higher level than a middle position (central position) with respect to the height 50H on the central line 50L of the valve body 50 (see FIG. 5). In this embodiment, the buoyancy center 14F is set to be adjacent to the upper end surface 50c while the buoyancy center 14F is positioned on the lower side of the upper end surface 50c. However, the buoyancy center 14F may be set at any position as long as it is positioned at a higher level than the middle position with respect to the height 50H on the central line 50L. The buoyancy center 14F may preferably be set to be higher than ⅔ of the height 50H on the central line 50L, more preferably to be higher than ¾ of the height 50H, most preferably to be higher than ⅘ of the height 50H. The term “buoyancy center” used in this specification means a point where the buoyancy is applied to the float valve 14 by the fuel.

The positions of the gas communication holes 35 are determined based on the position of the buoyancy center 14F of the float valve 14. Thus, the positions of the gas communication holes 35 are determined such that they are higher than the buoyancy center 14 when the float valve 14 is at the lowermost position. In this embodiment, the positions of the gas communication holes 35 are determined such that they are higher than the buoyancy center 14 by a distance corresponding to a stroke of movement of the valve portion 15 of the float valve 14 for closing the fuel vapor outlet hole 32a. Alternatively, the distance may substantially correspond to the moving stroke of the valve portion 15 when the float valve 14 is at the lowermost position. However, the positions of the gas communication holes 35 (more specifically, the center of each of the gas communication holes 35) may be set such that they are substantially the same level as the buoyancy center 14F or to be higher than the buoyancy center 14F when the float valve 14 is at the lowermost position.

The gas communication holes 35 are designed such that the loss of gas pressure flowing though the gas communication holes 35 is smaller than the loss of gas pressure flowing through the fuel vapor outlet hole 32. In other words, an open area of the gas communication holes 35, i.e., the sum of open areas of the gas communication holes 35, is set to be larger than the open area of the fuel vapor outlet hole 32. In this embodiment, the gas communication holes 35 have the same open area as each other.

The operation of the fuel cut-off valve assembly 10 will now be described. During the normal condition, fuel level L within the fuel tank 26 may be positioned below the housing 12 of the fuel cut-off valve assembly 10. Therefore, in this state, the valve portion 51 of the float valve 14 is positioned downwardly away from the valve seat 32a to open the fuel vapor outlet hole 32. In this open state of the float valve 14, fuel vapor that may be generated and accumulated at the gas occupied region 28 within the fuel tank 26 may flow into the float chamber 43 via the gas communication holes 35 and the communication holes 40. Afterwards, fuel vapor may then flow through the communication chamber 45 and the connection passage 34 of the communication path via the fuel vapor outlet hole 32, and thereafter flow into the canister 48 via the piping member 47.

When the vehicle (fuel tank 26) has been tilted, the fuel within the fuel tank 26 may flow into the float chamber 43 via the communication holes 40 of the housing 12. If the fuel level L becomes higher than the buoyancy center 14F of the float valve 14, the float valve 14 may float upward due to its buoyancy and the biasing force of the valve spring 16, causing the valve portion 51 of the float valve 14 to be seated on the valve seat 32a of the housing 12. Therefore, the fuel vapor outlet hole 32 may be closed as shown in FIG. 3. As a result, the fuel (liquid fuel) within the fuel tank 26 may be prevented from flowing from the fuel vapor outlet hole 32 into the canister 48. When the vehicle has been overturned, the float valve 14 may close the fuel vapor outlet hole 32 via the gravity of the float valve 14 and the biasing force of the valve spring 16.

As the vehicle returns from the tilted position or the overturned position to the normal position, the fuel within the float chamber 43 may flow downward into the fuel tank 26 via the communication holes 40, so that the float valve 14 may move to the lowermost position or the open position.

During the normal condition of the vehicle, the valve member 60 of the relief valve 56 is held against the valve seat 59 by the biasing force of the relief spring 61, so that the relief valve 56 is held at the closed position (see FIG. 2). When the pressure within the gas occupied region 28 of the fuel tank 26 exceeds a predetermined value, the valve member 60 moves away from the valve seat 59 (and against the biasing force of the relief spring 61), so that the relief valve 56 is brought to an open position. Therefore, the relief passage 58 formed to detour the fuel vapor outlet hole 32 of the cut-off valve assembly 10 provides communication between the communication chamber 45 and the float chamber 43, so that the pressure of the gas occupied region 28 within the fuel tank 26 may be released. As a result, it is possible to prevent the pressure of the gas in the occupied region 28 from exceeding the predetermined value. When the pressure of the gas in the occupied region 28 becomes less than the predetermined value, the relief valve 56 is brought to a closed position by the biasing force of the relief spring 61.

As described above, according to the fuel cut-off valve assembly 10 of this embodiment, the valve body 50 of the float valve 14 has a flattened shape (see FIG. 5). Therefore, it is possible to set the full load fuel level L at a higher position (see FIG. 2) than in the case where the valve body 50 does not have a flattened shape. Further, because the buoyancy center 14F is set to be higher than the middle position with respect to the height 50H of the valve body 50 (see FIG. 5), it is possible to set the full load fuel level L at a higher position also in this respect. Hence, it is possible to reduce the dead space within the fuel tank 6 and to increase the fuel capacity of the fuel tank 26.

In addition, the positions of the gas communication holes 35 are determined such that they are higher than the buoyancy center 14F when the float valve 14 is positioned at the lowermost position (see FIG. 2). Therefore, fuel droplets that may be spread due to ruffling of the surface of fuel at the fuel level F within the fuel tank 26 may be prevented from flowing into the communication holes 35 and being discharged from the fuel vapor outlet hole 32 via the float chamber 43.

Further, the open areas of the communication holes 35 are determined such that the loss of pressure of gas flowing through the communication holes 35 is smaller than the loss of pressure of gas flowing through fuel vapor outlet hole 32. Therefore, it is possible to prevent the pressure within the float chamber 43 from becoming lower than the pressure of the gas occupied region 28 within the fuel tank 26, for example, when the vehicle is tilted or overturned. Hence, it is possible to prevent leakage of fuel from the fuel vapor outlet hole 32, for example, when the fuel level within the float chamber 43 is abruptly raised prior to closing the float valve 14.

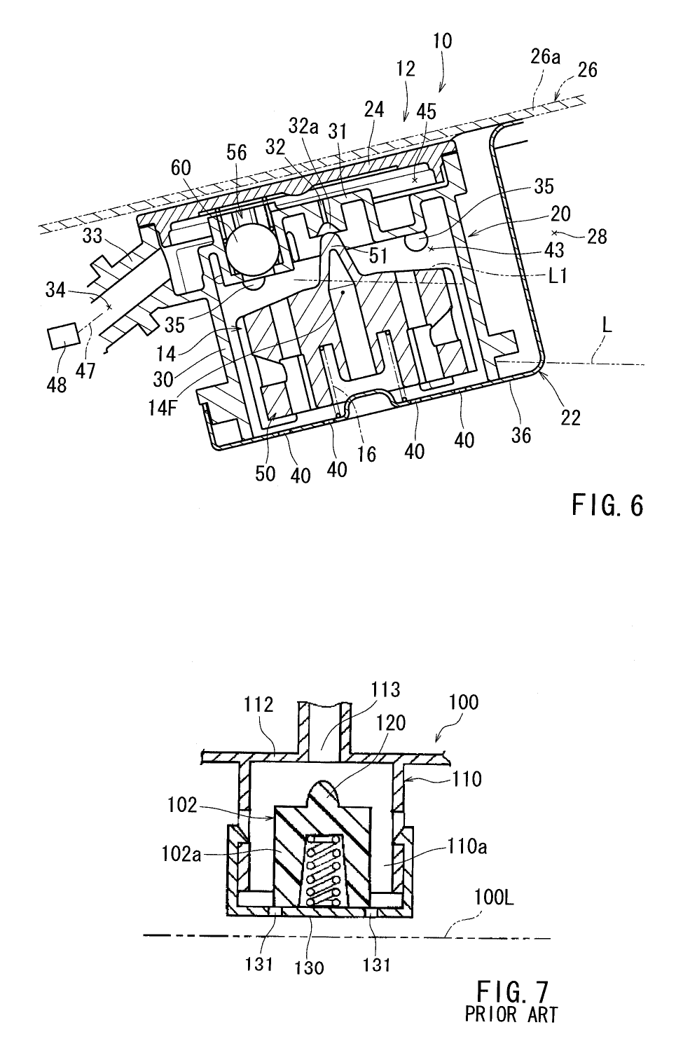

This function will be further described with reference to FIG. 6 that shows the state where the fuel cut-off valve assembly 10 is tilted. In the case that the loss of pressure of gas flowing through the communication holes 35 is larger than the loss of pressure of gas flowing through the fuel vapor outlet hole 32, it may be possible that the pressure in the gas occupied region 28 within the fuel tank 26 becomes larger than the pressure within the float chamber 43, which may be substantially equal to the atmospheric pressure, when the fuel level is changed or when the fuel temperature is increased. In this case, when the vehicle (or the fuel tank 26) is tilted or overturned, it may be possible that the pressure within the float chamber 43 becomes lower than the pressure of the gas occupied space 28 within the fuel tank 26 due to loss of pressure of gas when flowing through the communication holes 35. Therefore, the fuel level L within the float chamber 43 may abruptly rise to a level L1 shown in FIG. 6 before the float valve 14 is closed. In an extreme instance, the fuel may flow out of the fuel vapor outlet hole 32 to cause leakage of fuel. This situation may tend to be brought about, in particular in the situation where the gas communication holes 35 are set to be higher than the buoyancy center 14F of the float valve 14 positioned at the lowermost position.

In contrast, according to the above embodiment, the open areas of the communication holes 35 are determined such that the loss of pressure of gas flowing through the communication holes 35 is smaller than the loss of pressure of gas flowing through the fuel vapor outlet hole 32. Therefore, even in the situation where the pressure of the gas occupied region 28 of the fuel tank 26 has been increased, the pressure within the float chamber 43 may be brought to be relatively equal to the pressure within the gas occupied region 28. Hence, even though the communication holes 35 are set to be higher than the buoyancy center 14F of the float valve 14 positioned at the lowermost position, it is possible to prevent an abrupt rise in the fuel level L1 within the float chamber 43 prior to closing the float valve 14. Thus, the float valve 14 may move upward in response to rise of the fuel level L1 within the float chamber 43, so that potential leakage of fuel through the fuel vapor outlet hole 32 due to an abrupt rise of the fuel level L1 can be inhibited.

The above embodiment may be modified in various ways. For example, the above teachings can be applied to any other valves, such as a full-load control valve that can shut-off a gas communication system when the fuel level within a fuel tank reaches a full load level. The upper surface 50a and the upper end surface 50c of the valve body 50 may be formed to extend within a same plane. The valve body 50 may have a shape other than the cylindrical shape. The number and the shapes of the communication holes 35 as well as those of the communication holes 40 can be suitably determined. Further, the communication holes 40 may be formed in the lower end of the side wall 30 of the float chamber 43.

What is claimed is:

1. A fuel cut-off valve assembly for mounting within a fuel tank that customarily stores liquid fuel in a bottom section and stores vapor produced by the liquid fuel in an upper section, comprising:
a float chamber housing located within the upper section of the fuel tank and having a float chamber located therein, wherein
the float chamber housing has at least one first communication hole located near a lower portion of the float chamber, at least one second communication hole formed in a side wall of the float chamber housing and a fuel vapor outlet hole formed in an upper wall of the float chamber housing;
a float valve moveable vertically within the float chamber housing,
the float valve including a float valve body and a float valve portion configured to close the fuel vapor outlet hole as the float valve moves upward due to buoyancy applied by fuel flowing into the float chamber;
the float valve body having a flattened shape, so that a buoyancy center of the float valve is positioned to be higher than a midpoint height of the float valve body.

2. The fuel cut-off valve assembly according to claim 1, wherein:
the at least one second communication hole is positioned at substantially the same level as or higher than the buoyancy center when the float valve is at a lowermost position within the float chamber housing.

3. The fuel cut-off valve assembly according to claim 2, wherein a loss in gas pressure flowing through the at least one second communication hole is determined to be smaller than a loss in gas pressure flowing though the fuel vapor outlet hole.

4. The fuel-cut off valve assembly according to claim 1, wherein the float valve body of the float valve has a substantially cylindrical shape and has a height in the vertical direction and a diameter in a horizontal direction perpendicular to the vertical direction, the height being smaller than the diameter.

5. A fuel cut-off valve assembly comprising:
a float chamber housing disposed within a fuel tank and having a float chamber located therein; and
a float valve located within the float chamber so as to be vertically movable between an upper stroke end and a lower stroke end; wherein:
the float chamber housing includes at least one first communication hole communicating between the float chamber and an inside of the fuel tank at a first level, at least one second communication hole communicating between the float chamber and an inside of the fuel tank at a second level higher than the first level, and a fuel vapor outlet hole communicating between the float chamber and a passage connected to a fuel vapor processing device;
the float valve configured to close the fuel vapor outlet hole as the float valve moves upward from the lower stroke end to the upper stroke end due to buoyancy applied by fuel flowing into the float chamber at least via the at least one first communication hole;
the float valve having a float valve body having a height in the vertical direction;
the float valve having a buoyancy center positioned at a higher level than a central height position of the float valve body; and
the at least one second communication hole defines a first opening area, and the fuel vapor outlet hole defines a second open area smaller than the first open area.

6. The fuel cut-off valve assembly according to claim 5, wherein the at least one second communication hole is positioned at substantially the same level as the buoyancy center or higher than the buoyancy center when the float valve is at the lower stroke end.
